(19) United States
(12) Patent Application Publication
(10) Pub. No.: US 2013/0283622 A1
(43) Pub. Date: Oct. 31, 2013

(54) HAND-HELD ELECTRIC CUTTING MACHINE

(71) Applicants: Naoya Eto, Niigata (JP); Fumio Karasawa, Niigata (JP)

(72) Inventors: Naoya Eto, Niigata (JP); Fumio Karasawa, Niigata (JP)

(73) Assignee: NAKAYA CO., LTD., Sanjyo-shi, Niigata (JP)

(21) Appl. No.: 13/805,157

(22) PCT Filed: Jan. 19, 2012
(86) PCT No.: PCT/JP2012/051086

§ 371 Date: Dec. 18, 2012

(30) Foreign Application Priority Data
Jan. 21, 2011 (JP) 2011-025415

(51) Int. Cl. B26B 29/00; B26B 25/00

(52) U.S. Cl. CPC B26B 29/00; B26B 25/002
USPC 30/164

(57) ABSTRACT

Provided is a hand-held electric cutting machine having excellent spark control capability, high stability, good usability and high versatility. A unit having: a first guard which covers a part of a disc-shaped cutting tool; a second guard which covers a part of the disc-shaped cutting tool and is rotatably attached to the first guard; a movable guard which is rotatable around outer peripheries of the first guard and the second guard, covers a part of the disc-shaped cutting tool, and is attached on the second guard; and a protector which covers an outside of the movable guard and is attached on the second guard, is attached to a hand-held electric tool serving as a driving source.

### TECHNICAL FIELD

The present invention relates to a hand-held electric cutting machine controlling sparks generated when a steel pipe, a steel sheet or the like is cut with a disc-shaped cutter.

### BACKGROUND ART

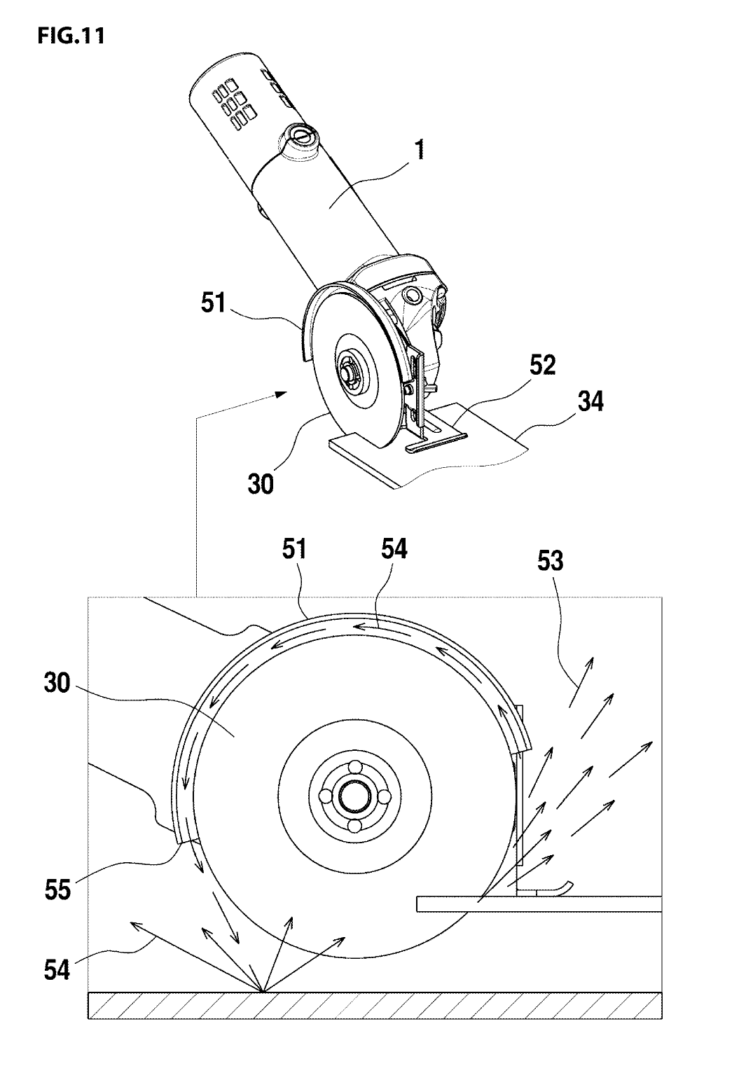

Generally, when machining a small-sized steel pipe, steel sheet or the like with a cutting grindstone, the machining work is often performed by a hand-held electric cutting machine represented by a disc grinder 1 with a dedicated guard 51 and base 52 attached thereto as shown in FIG. 11. Sparks 53 generated during the cutting, however, scatter in large quantity obliquely upward along the direction of rotation of a cutting grindstone 30 and, in the case of outdoor work, the flying sparks sometimes fall on an operator depending on the direction of wind. In addition, a part of sparks 54 sometimes passes by the inner periphery of the guard 51, blows out from a rear end part 55, bounces on the ground back to the operator, and possibly causes injury such as a burn to the operator depending on the situation.

On the other hand, there are tip saws for metal generating a smaller quantity of sparks and enabling more highly-efficient cutting in the present market, but the tip saws cannot be used in the above-described hand-held electric cutting machine in terms of safety problem.

In contrast, a circular saw described in Japanese Patent Laid-open Publication No. Hei 7-205101 can machine a steel pipe and a steel sheet using the above-described cutting grindstone or the tip saw for metal, in which a surface plate that is a part of its components stabilizes the cutting posture and a movable guard rotating about the rotational axis of a cutter exhibits, to a certain degree, an effect of preventing scattering of the sparks. However, there still remains a possibility that sparks flowing into a space between the inner periphery of the guard and the outer periphery of the movable guard blow out from a rear end part of the guard and bounce on the ground back to an operator as in the above-described disc grinder.

Further, the front part of the cutter of the circular saw is widely open for exchange of the cutter and a large quantity of sparks scatters also from the front part. Moreover, since a pivot part for rotational movement of the movable guard is provided inside the guard, fine dust generated during the cutting, easily intrudes into the pivot part and consequently tends to cause failure of operation of the movable guard.

In such a situation, in an example introduced in Japanese Patent Laid-open Publication No. 2002-283134, a cutter is nearly entirely covered with two sets of fixed covers and movable covers and is configured such that when the movable cover comes into contact with a work material, a part of the cutter is exposed from a slit on the cover and performs cutting, so as to prevent scattering of sparks. However, accumulation of the sparks inside the covers is not preferable in safety because of problem of ignition.

Further, since the aforementioned example has a structure in which the cover on the side contacting the work material operates, there is no member, such as the above-described base or surface plate, which comes into contact with the work material and serves to stabilize the cutting posture, so that the operation becomes unstable and tends to apply load in an inappropriate direction with respect to the cutting grindstone and, as a result, to cause breakage of the cutting grindstone, thereby possibly bringing about a serious accident in which broken pieces scatter into an eye of the operator and lead the operator to blindness.

On the other hand, in an example introduced in Japanese Registered Utility Model Publication No. 3008934, a movable guard having a rotational axis and moving to follow in a direction of discharge of sparks is provided at the front part of a cutter to prevent scattering of sparks. However, it is necessary to rotate the cutter and a work material in opposite directions in order to stabilize the cutting operation and the movement of a main body is limited to the rotational movement about a separately provided pivot, as described in this document, and therefore it should be said that its workability and general versatility is low.

As described above, there has been no hand-held electric cutting machine, so far, which has high spark control capability and high stability for its operation, and is easy to use.

### PRIOR ART DOCUMENT

Patent Document

Patent Document 1: Japanese Patent Laid-open Publication No. Hei 7-205101

Patent Document 2: Japanese Patent Laid-open Publication No. 2002-283134

Patent Document 3: Japanese Registered Utility Model Publication No. 3008934

### DISCLOSURE OF THE INVENTION

Problems to Be Solved by the Invention

The hand-held electric cutting machines for machining steels, which have been designed so far, are not satisfactory, mainly because of safety problems such as control of sparks generated during cutting, stability of cutting operation.

An object of the present invention is to solve the above-mentioned problems, and provide a hand-held electric cutting machine which has excellent spark control capability, high stability, good usability and high versatility. Means for Solving the problems

The above object is achieved by attaching a unit having guards which cover a cutting tool, a movable guard which is rotatable around outer peripheries of the guards, and a protector which covers an outer periphery of the movable guard, to a hand-held electric cutting tool serving as a driving source.

Effect of the Invention

The hand-held electric cutting machine according to the present invention makes it possible to collectively discharge in a safe direction sparks generated during cutting of a steel and to make the cutting operation more stable and efficient.

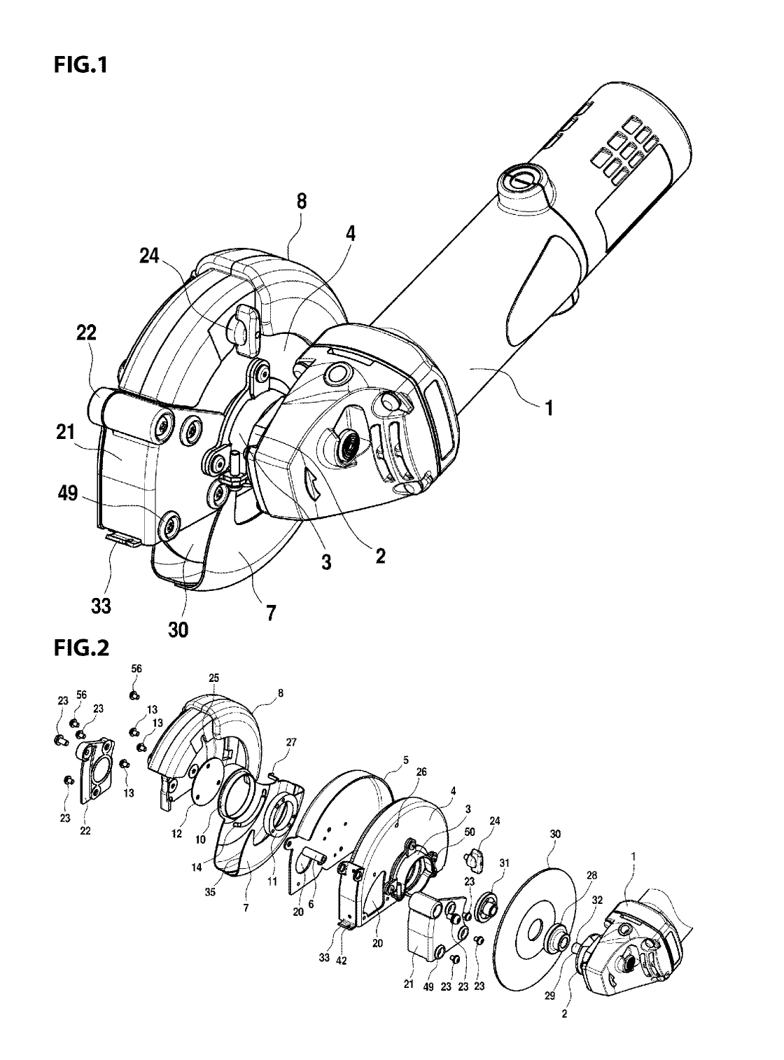

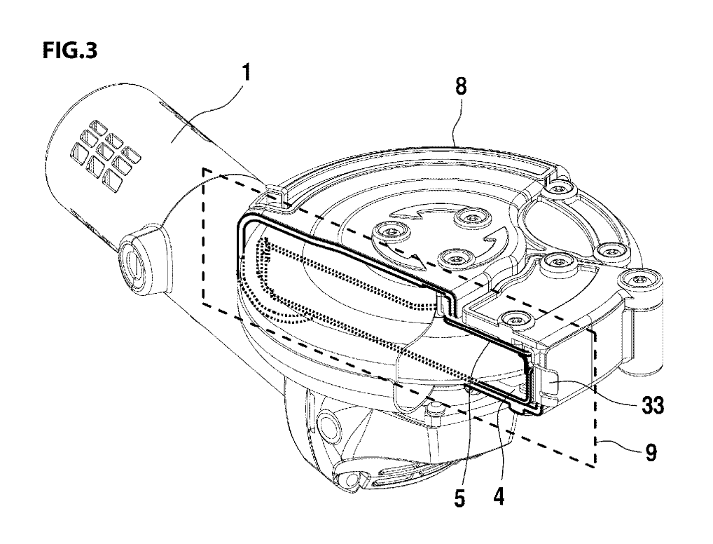

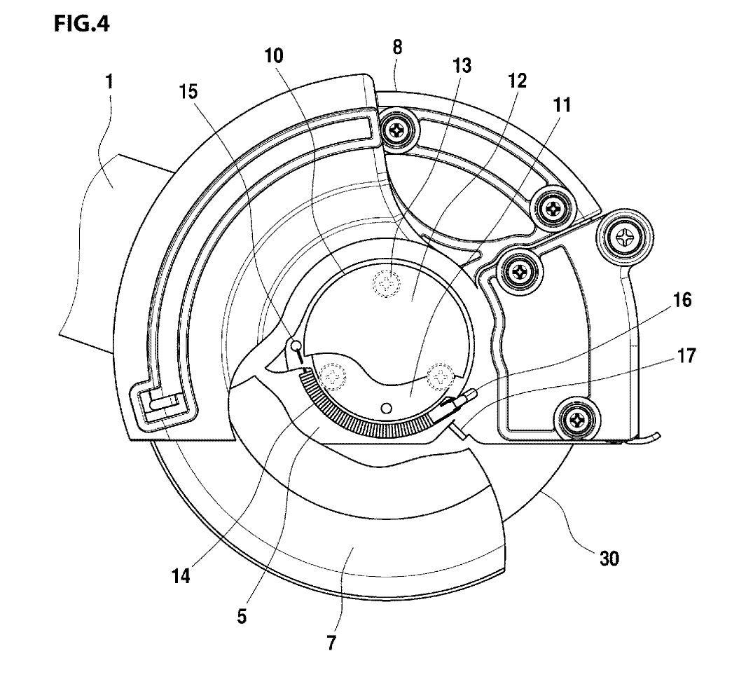

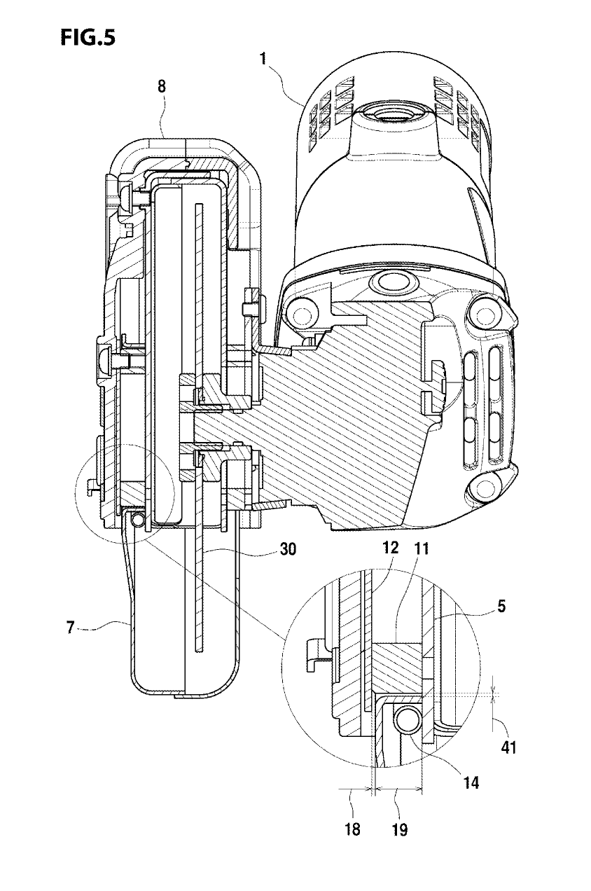

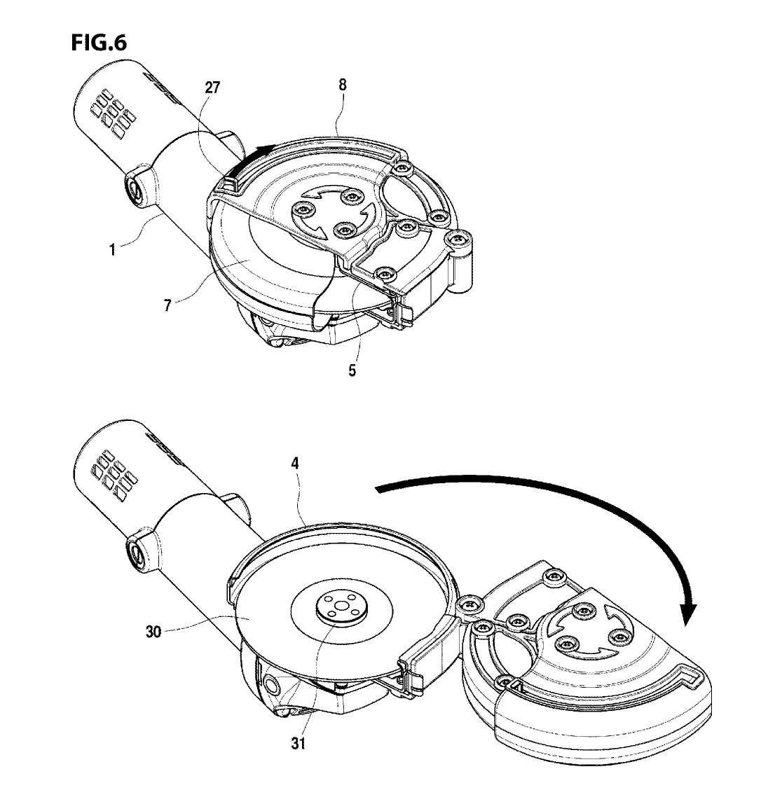

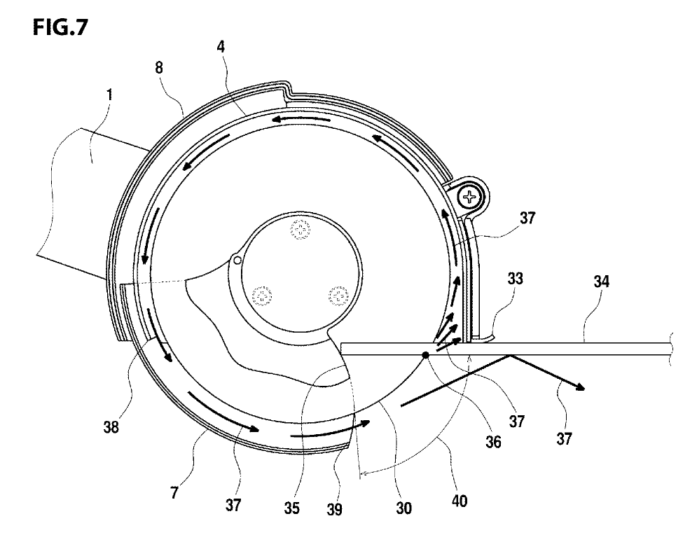

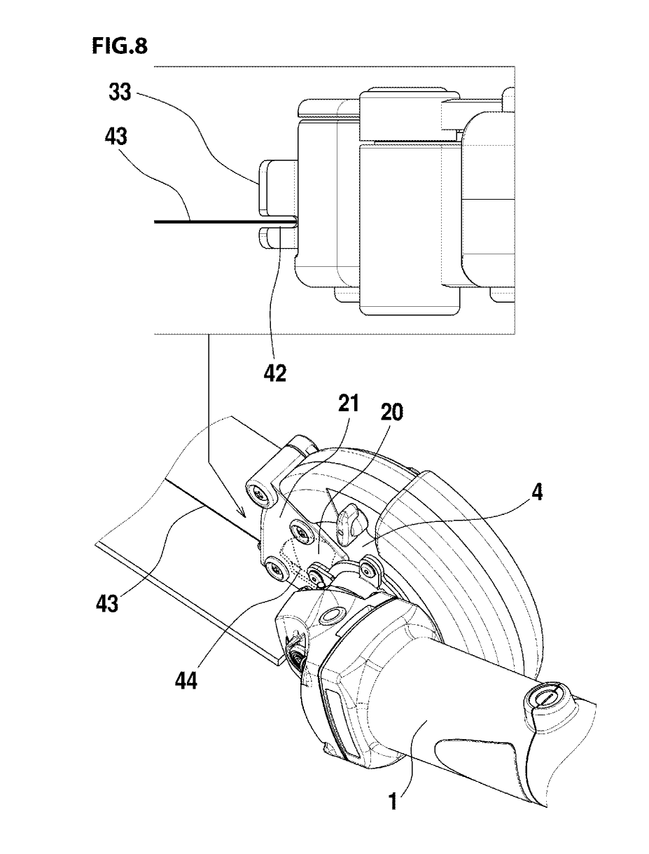

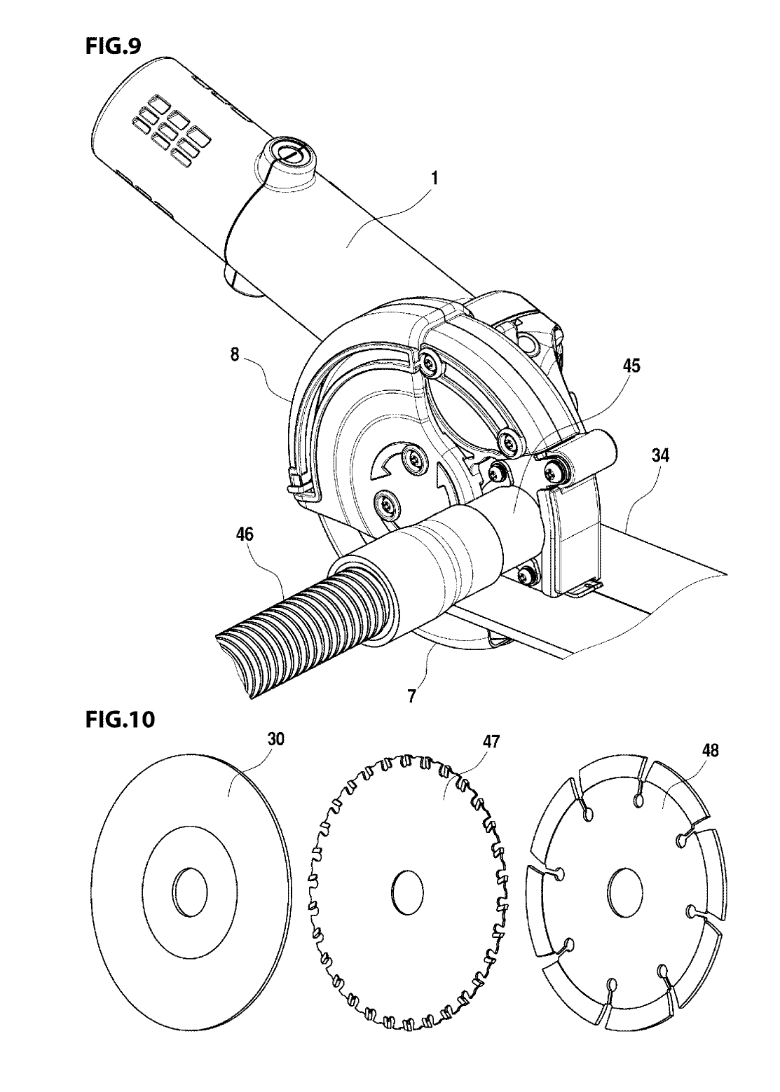

### BRIEF DESCRIPTION OF DRAWINGS

[FIG. 1] A perspective view showing an entire configuration of a hand-held electric cutting machine according to the present invention.

[FIG. 2] An exploded perspective view showing an internal configuration of the hand-held electric cutting machine according to the present invention.

[FIG. 3] A perspective view showing a bottom surface state of the hand-held electric cutting machine according to the present invention.

[FIG. 4] A partial sectional view of a side surface showing the internal configuration of the hand-held electric cutting machine according to the present invention.

[FIG. 5] A partial sectional view of a front surface showing the internal configuration of the hand-held electric cutting machine according to the present invention.

[FIG. 6] A perspective view showing a situation in exchanging a cutting tool of the hand-held electric cutting machine according to the present invention.

[FIG. 7] A partial sectional view of a side surface showing an embodiment of the hand-held electric cutting machine according to the present invention.

[FIG. 8] A perspective view and a partial top view showing the embodiment of the hand-held electric cutting machine according to the present invention.

[FIG. 9] A perspective view showing another embodiment of the hand-held electric cutting machine according to the present invention.

[FIG. 10] A perspective view showing examples of the cutting tool used in the hand-held electric cutting machine according to the present invention.

[FIG. 11] A perspective view and a partial sectional view of a side surface showing an example of a conventional hand-held electric cutting machine.

### DESCRIPTION OF EMBODIMENTS

A hand-held electric cutting machine according to the present invention is configured such that a first guard 4 made of steel is attached to a guard attachment part 2 of a disc grinder 1 via a connector 3 as shown in FIG. 1, a second guard 5 made of steel is rotatably attached to the first guard 4 around a shaft 6 in a manner to cover the outer periphery of the first guard 4 as shown in FIG. 2, and a movable guard 7 made of steel and a protector 8 made of a transparent resin are attached on the second guard 5.

Further, as shown in FIG. 3, parts of the first guard 4, the second guard 5, and the protector 8 have edge parts made by being cut off along a plane, and when the respective members are combined, the edge parts form an edge surface 9 within the same plane.

The movable guard 7 has a concentric shape covering the outer periphery of the second guard 5 and has a ring 10 for coupling provided at its central part. On the other hand, on the second guard 5, a rotation base 11 having an outer diameter slightly smaller than an inner diameter of the ring 10 is fixed by welding to a central part thereof. In the state that the ring 10 is inserted into the rotation base 11 and a holder plate 12, that is a separate member is set on an upper surface of the rotation base 11, the protector 8 is fastened to the rotation base 11 by screws 13 together with the holder plate 12 and also fastened to the second guard 5 by screws 56.

In addition, as shown in FIG. 4, a spring 14 is set to follow the outer periphery of the ring 10 between the movable guard 7 and the second guard 5 and has one end attached to an attachment hole 15 on the movable guard 7 and the other end hooked on a hook 16 provided on the second guard 5. Further, a stopper 17 is provided on the second guard 5 and comes into contact, at a predetermined position, with the movable guard 7.

In this case, as shown in FIG. 5, a gap 18 between the holder plate 12 and the rotation base 11 is set to be slightly larger than a ring width 19 so that the movable guard 7 can perform a smooth rotational movement around the center of the rotation base 11, while being held on the second guard 5.

Windows 20 are provided at parts of side surfaces of the first guard 4 and the second guard 5, and a first side protector 21 and a second side protector 22, which are made of a transparent resin, are fixed on the respective windows by screws 23.

On a rear surface of a main body, a knob bolt 24 is fastened to a female screw 26 on the first guard 4 through a slit 25 provided on the protector 8 to indirectly fix the first guard 4 and the second guard 5.

By loosening the knob bolt 24 on the rear surface and then pulling up an operating lever 27 of the movable guard 7 as shown in FIG. 6, the second guard 5 and the movable guard 7 and the protector 8 simultaneously rotate around the shaft 6 in an interlocking manner to widely open the inside of the first guard 4. In this state, by inserting a flange 28 into a spindle 29, setting a cutting grindstone 30 on the flange 28, and fastening a lock nut 31 to a male screw part 32 of the spindle 29, the cutting grindstone 30 can be attached to the disc grinder 1.

For example, when a steel sheet is cut by the hand-held electric cutting machine according to the present invention, the disc grinder 1 is powered on first, and after it is confirmed that the cutting grindstone 30 has reached a certain rotational speed, a guide 33 provided on the first guard 4 is placed on a steel sheet 34 as shown in FIG. 7, and the disc grinder 1 is pressed forward as it is. Then, a head part 35 of the movable guard 7 comes into contact with the steel sheet 34, its acting force rotates the movable guard 7, and the cutting grindstone 30 thus exposed comes into contact with the steel sheet 34 and starts cutting.

Sparks 37, generated at a contact point 36 between the cutting grindstone 30 and the steel sheet 34, scatter obliquely upward along the rotational direction of the cutting grindstone 30, then come around behind along the side walls of the guards existing ahead, and flow out of a rear end part 38. However, because the outer peripheral parts of the guards are covered with the movable guard 7, all of the sparks 37 never leak to the outside but go around in the inner peripheral part of the movable guard 7, and finally are collectively discharged from a tip end part 39 of the movable guard 7. In this event, unlike the conventional product, the sparks 37 are discharged under the steel sheet 34 and are thus never allowed to fly, to a height where they may fall on the operator.

When the cutting operation is proceeded as it is, an opening angle 40 of the movable guard 7 gradually increases and finally to nearly 180 degrees and the sparks 37 are discharged out of the rear end part 38 as in the conventional product. However, the position of the cutting grindstone 30 at that time has moved to a position far from the operator, so that there is a low risk.

Once the cutting operation is ended and the steel sheet 34 is separated from the hand-held electric cutting machine, the movable guard 7 is instantaneously restored by the acting force of the spring 14 to the regular position where the movable guard 7 comes into contact with the stopper 17.

Unlike the aforementioned circular saw, the rotation base 11, that is the pivot of the rotational movement of the movable guard 7, is set outside the guard and the rotation base 11 is entirely covered with the protector 8 in the hand-held electric cutting machine according to the present invention, so that dust generated during the cutting is unlikely to enter a gap 41 between the rotation base 11 and the ring 10, with the result that a functional capability for the smooth rotational movement of the movable guard 7 is maintained for a long time.

Further, because the acting force of holding a work material between the cutting grindstone 30 and the guide 33 acts during the cutting operation, the hand-held electric cutting machine according to the present invention can keep a stable working posture and suppress the risk such as breakage or the like of the cutting grindstone 30. Further, the edge parts of the guards and the protector form the edge surface 9 within the same plane as the bottom surface of the guide 33, so that when the cutting is proceeded, the edge surface 9 continuously functions as a surface plate to keep the stable working posture. The stable working posture eliminates excessive energy loss and accordingly enables realization of smoother and more highly efficient cutting.

When the operator wants to accurately cut a place of the work material, the operator can easily perform cutting on a cutting target line 43 by proceeding the cutting while aligning the center line of a cutout groove 42 with the cutting target line 43 because the center line of the cutout groove 42 provided in the guide 33 is configured to be aligned with the cutting position of the cutting grindstone 30.

Furthermore, it is possible to visually check the inside of the guard, in particular, a cutting edge part 44 of the cutting grindstone 30 over the first side protector 21 made of the transparent resin through the window 20 provided in the side surface of the first guard 4 as shown in FIG. 8, and therefore it is also possible to more sensuously target the cutting target line 43. Note that since the scattering direction of the sparks is positioned nearly parallel with the surface provided with the window 20, little or no sparks hit the window 20, and the first side protector 21 covering the window 20 does not come to melt.

When a material generating no sparks is cut by the hand-held electric cutting machine according to the present invention, the second side protector 22 attached to the side surface of the second guard 5 may be detached, a duct connector 45 shown in FIG. 9 may be attached instead, and a hose 46 of a dust collector (not shown in Figures) is connected to the duct connector 45, thereby enabling collection of dust and chips generated during the cutting when necessary.

Note that the aforesaid material generating no sparks means, for example, wood material, gypsum board, concrete or the like, and when machining these materials, various kinds of cutting tools such as a tip saw 47 and a diamond cutter 48 as shown in FIG. 10 can be selectively used depending on usage in place of the cutting grindstone 30, because the safety of the hand-held electric cutting machine according to the present invention is ensured by employing the movable guard 7.

The protector 8 covers the outer periphery of the movable guard 7 to prevent the operator from mistakenly touching with the movable guard 7, which performs rotational movement on the outer peripheries of the guards and also provides a function of isolating the operator from the guards made of steel generating heat during the operation so as to reduce the risk of burn or the like. Similarly, the fastening part of each screw is designed to the operator away from the screw part generating heat by providing a wall shape 49 at the peripheral part of a hole for attaching the screw of the protector.

The connector 3 attached to the first guard 4 may be freely exchanged with the one having another shape by removing fixing screws 50 at three positions, and thereby attachable to various types of disc grinders.

Note that though the materials of the guards and the protector are described in the above, it is not always necessary to employ the materials designated in this document, depending on an object work material and the kind of cutter. The mechanisms of the first guard 4, the second guard 5, and the movable guard 7 are not limited to the rotational type introduced in this document, but another mechanism such as a detachable type may be employed. Further, the components illustrated in the above embodiment may be composed in an integrally molded type unless otherwise there is no technical and strength problems.

Explanation of Codes

1 disc grinder

2 guard attachment part

3 connector

4 first guard

5 second guard

6 shaft

7 movable guard

8 protector

9 edge surface

10 ring

11 rotation base

12 holder plate

13 screw

14 spring

15 attachment hole

16 hook

17 stopper

18 gap

19 ring width

20 window

21 first side protector

22 second side protector

23 screw

24 knob bolt

25 slit

26 female screw

27 operating lever

28 flange

29 spindle

30 cutting grindstone

31 lock nut

32 male screw part

33 guide

34 steel sheet

35 head part

36 contact point

37 spark

38 rear end part

39 tip end part

40 opening angle

41 gap

42 cutout groove

43 cutting target line

44 cutting edge part

45 duct connector

46 hose

47 tip saw

48 diamond cutter

49 wall shape

50 fixing screw

51 guard

52 base

53 spark

54 spark

55 rear end part

56 screw

1. A hand-held electric cutting machine comprising: a disc-shaped cutting tool which is attached to a rotary drive apparatus; a first guard which is attached to the rotary drive apparatus and covers a part of the disc-shaped cutting tool; a second guard which covers a part of the disc-shaped cutting tool and is rotatably attached to the first guard; a movable guard which is rotatable around outer peripheries of the first guard and the second guard, covers a part of the disc-shaped cutting tool, and is attached on the second guard; and a protector which covers an outside of the movable guard and is attached on the second guard, wherein the first guard, the second guard, and the protector are formed in a shape so that each of lower ends of the first guard, the second guard, and the protector is cut off along a uniform plane.
